(19) United States
(12) Patent Application Publication
(10) Pub. No.: US 2019/0141452 A1
(43) Pub. Date: May 9, 2019

(54) SPEAKER MODULE

(71) Applicant: Acer Incorporated, New Taipei City (TW)

(72) Inventors: Jia-Ren Chang, New Taipei City (TW); Wan-Chi Lin, New Taipei City (TW)

(73) Assignee: Acer Incorporated, New Taipei City (TW)

(21) Appl. No.: 16/004,442

(22) Filed: Jun. 11, 2018

Related U.S. Application Data
(60) Provisional application No. 62/583,505, filed on Nov. 9, 2017.

(30) Foreign Application Priority Data
Mar. 23, 2018 (TW) 107109942

(51) Int. Cl. H04R 9/02; H04R 7/16

(52) U.S. Cl. CPC H04R 9/02; H04R 7/16

(57) ABSTRACT

A speaker module including a diaphragm structure, a rear sound box and a cavity is provided. The diaphragm structure has a front end and a rear end that are opposite to each other. The rear sound box connects to the rear end of the diaphragm structure. The cavity connects to the front end of the diaphragm structure and has a sound output opening.

### CROSS-REFERENCE TO RELATED APPLICATION

This application claims the priority benefits of U.S. provisional application Ser. No. 62/583,505, filed on Nov. 9, 2017, and Taiwan application serial no. 107109942, filed on Mar. 23, 2018. The entirety of each of the above-mentioned patent applications is hereby incorporated by reference herein and made a part of this specification.

### BACKGROUND

### Technical Field

The disclosure relates to a speaker module, and particularly relates to a speaker module in which a cavity is provided at a front end of a diaphragm structure.

### Description of Related Art

As technology advances, human beings, in pursuing convenience, have made portable electronic products become increasingly lightweight in size. However, due to space and size limitations, speakers used in tablet computers and in notebook computers of detachable, pluggable and flip types do not perform well at low frequencies.

For the purpose of enhancing the low frequency performance of the speakers of the portable electronic products, a woofer system is usually provided besides the existing speaker, and the volume of the rear sound box thereof is used to generate the low frequency sound. However, the rear sound box of a general woofer must have a large enough volume in order to deliver the desired low frequency performance, and is therefore not suitable for use in lightweight portable electronic products in terms of size.

### SUMMARY

The disclosure provides a speaker module that has a good low frequency performance and saves configuration space.

The speaker module of this disclosure includes a diaphragm structure, a rear sound box and a cavity. The diaphragm structure has a front end and a rear end that are opposite to each other. The rear sound box connects to the rear end of the diaphragm structure. The cavity connects to the front end of the diaphragm structure and has a sound output opening.

Based on the foregoing, in the speaker module of this disclosure, not only is the rear end of the diaphragm structure is provided with the rear sound box, but the front end of the diaphragm structure is further provided with the cavity. In the case where the volume of the rear sound box is too small to achieve the desired low frequency performance by itself, the cavity may enhance the low frequency performance of the speaker module by filtering out high frequency sound waves and/or by generating low frequency sound waves by resonance. Accordingly, it is not necessary to meet the requirement of low frequency performance by increasing the volume of the rear sound box, thereby saving the configuration space of the speaker module in the electronic device.

To make the aforementioned and other features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an electronic device according to an embodiment of this disclosure.

FIG. 2 is a top view of a partial structure of the speaker module of FIG. 1.

FIG. 3 is a side view of a partial structure of the diaphragm structure of FIG. 2.

FIG. 4 is a top view of a partial structure of a speaker module according to another embodiment of this disclosure.

### DESCRIPTION OF THE EMBODIMENTS

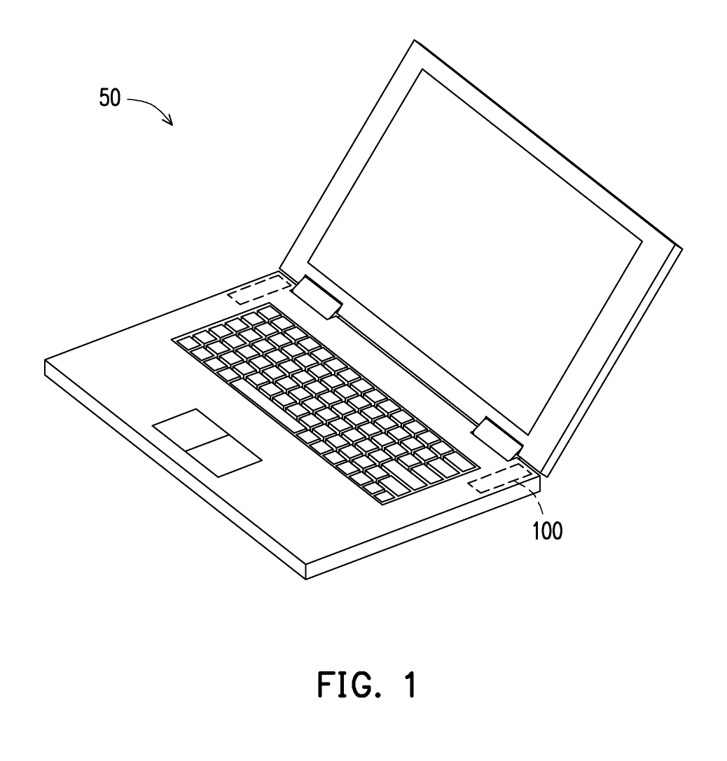

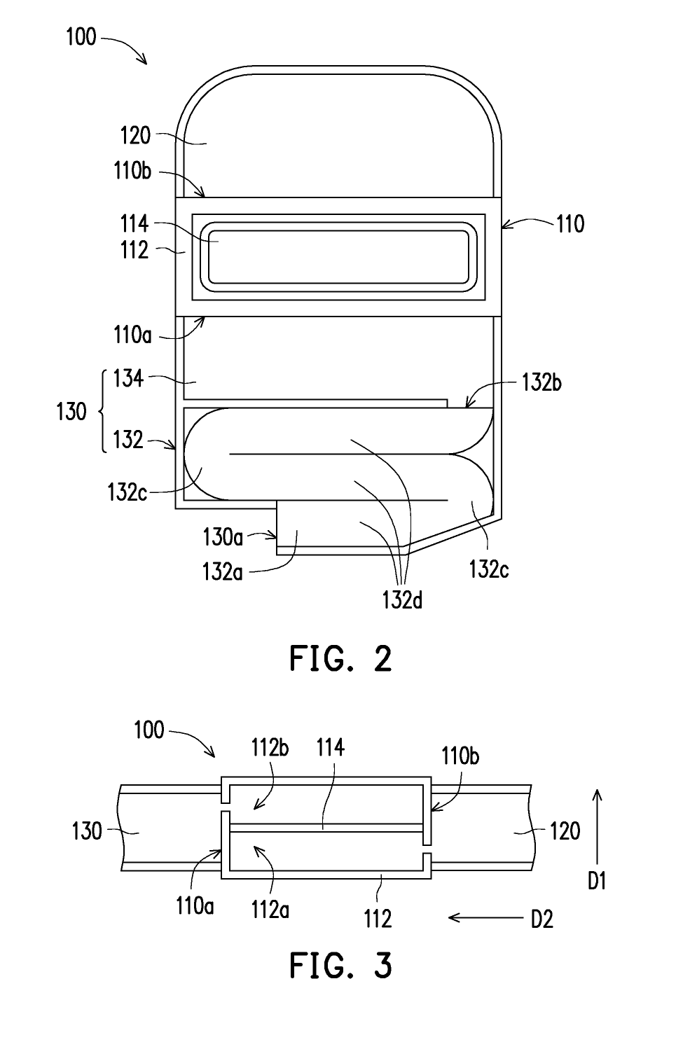

FIG. 1 is a schematic view of an electronic device according to an embodiment of this disclosure. FIG. 2 is a top view of a partial structure of the speaker module of FIG. 1. With reference to FIG. 1 and FIG. 2, a speaker module 100 of this embodiment is disposed in a host of an electronic device 50. The electronic device 50 is, for example, a notebook computer. The speaker module 100 includes a diaphragm structure 110, a rear sound box 120 and a cavity 130. The diaphragm structure 110 has a front end 110a and a rear end 110b that are opposite to each other. The rear sound box 120 connects to the rear end 110b of the diaphragm structure 110. The cavity 130 connects to the front end 110a of the diaphragm structure 110 and has a sound output opening 130a.

Under this configuration, not only is the rear end 110b of the diaphragm structure 110 is provided with the rear sound box 120 that speakers generally have, but the front end 110a of the diaphragm structure 110 is further provided with the cavity 130. In the case where the volume of the rear sound box 120 is too small to achieve the desired low frequency performance by itself, the cavity 130 may enhance the low frequency performance of the speaker module 100 by filtering out high frequency sound waves and/or by generating low frequency sound waves by resonance. Accordingly, it is not necessary to meet the requirement of low frequency performance by increasing the volume of the rear sound box 120, thereby saving the configuration space of the speaker module 100 in the electronic device 50. Specifically, by disposing the cavity 130 at the front end 110a of the diaphragm structure 110 so as to control the volume of the rear sound box 120, for example, to be greater than 0 ml and less than 4 ml (e.g., 1.7 ml), the speaker module 100 may be designed to be a small-sized structure having a length, a width and a thickness of 34 mm, 11 mm and 4 mm respectively, for example.

The structure and operation mode of the cavity 130 of this embodiment are described in detail as follows. With reference to FIG. 2, the cavity 130 of the speaker module 100 includes a waveguide 132 and a front sound box 134. The sound output opening 130a is disposed at an end 132a of the waveguide 132, and the front sound box 134 is connected between the front end 110a of the diaphragm structure 110 and another end 132b of the waveguide 132. The front sound box 134 may filter out the high frequency part of the sound wave from the diaphragm structure 110. The waveguide 132 may resonate the sound wave from the diaphragm structure 110 into a desired low frequency sound wave so as to enhance the low frequency performance of the speaker module 100. The sound wave generated by the diaphragm structure 110 may sequentially pass through the front sound box 134 and the waveguide 132 to reach the sound output opening 130a, so that the speaker module 100 generates a sound wave having a low frequency from the sound output opening 130a.

Specifically, the volume of the front sound box 134 is, for example, in a range of 0.13 to 2 ml (e.g., 1.6 ml) so as to filter out high frequency sound waves in a specific frequency band. In addition, the total length of the waveguide 132 is, for example, a multiple of a quarter of the wavelength of the frequency of the desired low frequency sound wave, such as 85 mm, and the cross-sectional area of the waveguide 132 is, for example, in a range of 10 to 20 mm² (e.g., 13.2 mm²) so that the equivalent volume thereof is, for example, in a range of 1 to 3 ml (e.g., 1.2 ml), thereby generating the desired low frequency sound wave by resonance. The low frequency, for example, does not exceed 300 Hz.

In this embodiment, the waveguide 132 has at least one bent portion 132c (illustrated as two here) and a plurality of sections 132d that are parallel to each other. Each bent portion 132c is connected between two of the parallel sections 132d of the waveguide 132 so that the waveguide 132 is generally in a zigzag shape, thereby preventing the waveguide 132 from extending too excessively and thus increasing the size of the speaker module 100. In other embodiments, the waveguide 132 may extend in other suitable ways. The disclosure is not limited thereto.

The specific structure of the diaphragm structure 110 of this embodiment is described in detail as follows. FIG. 3 is a side view of a partial structure of the diaphragm structure of FIG. 2. With reference to FIG. 3, the diaphragm structure 110 of this embodiment includes a housing 112 and a diaphragm 114. The diaphragm 114 is disposed inside the housing 112 and divides the interior of the housing 112 into a first space 112a and a second space 112b. The diaphragm 114 may generate vibration according to an input signal. The first space 112a and the second space 112b provide the space required for the vibration of the diaphragm 114 and are respectively used for connecting to the rear sound box 120 and the cavity 130. In addition, in this embodiment, the diaphragm 114 vibrates along a vibration direction D1, the rear sound box 120, the diaphragm structure 110 and the cavity 130 are sequentially arranged along an arrangement direction D2, and the vibration direction D1 and the arrangement direction D2 are perpendicular to each other. In other embodiments, the vibration direction D1 of the diaphragm 114 may be parallel to the arrangement direction D2 of the rear sound box 120, the diaphragm structure 110 and the cavity 130. The disclosure is not limited thereto.

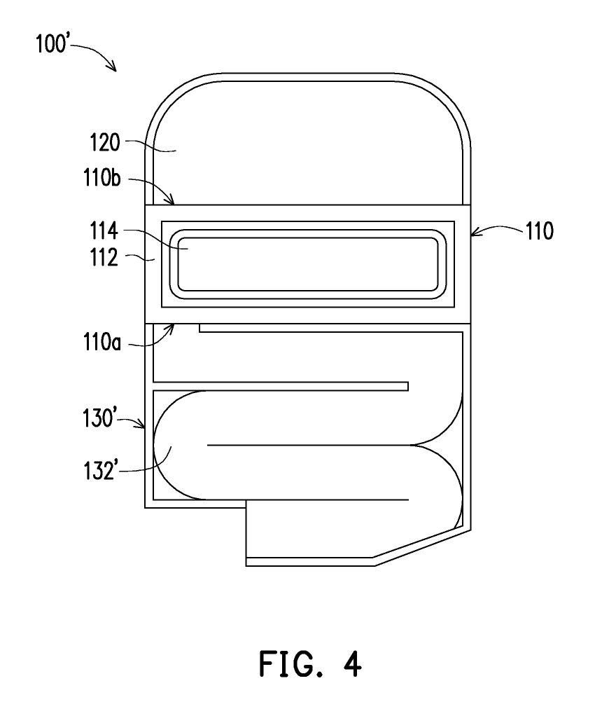

FIG. 4 is a top view of a partial structure of a speaker module according to another embodiment of this disclosure. The structural components thereof that are identical to those of the speaker module 100 in the embodiment shown in FIG. 2 are represented by the same reference numerals, and details thereof are not repeated hereinafter. A speaker module 100′ of the embodiment shown in FIG. 4 is different from the speaker module 100 of the embodiment shown in FIG. 2 in that a cavity 130′ of the speaker module 100′ does not have the front sound box 134 as shown in FIG. 2. Correspondingly, a waveguide 132′ has a length and a cross-sectional area different from those of the waveguide 132 as shown in FIG. 2 in order to generate the desired low frequency sound wave by resonance without the presence of the front sound box 134.

Specifically, the total length of the waveguide 132′ is, for example, a multiple of a quarter of the wavelength of the frequency of the desired low frequency sound wave, such as 120 mm, and the cross-sectional area of the waveguide 132′ is, for example, in a range of 10 to 20 mm² (e.g., 16.9 mm²) so that the equivalent volume thereof is, for example, in a range of 1 to 3 ml (e.g., 2.3 ml), thereby generating the desired low frequency sound wave by resonance. The low frequency, for example, does not exceed 300 Hz.

In summary, in the speaker module of this disclosure, not only is the rear end of the diaphragm structure is provided with the rear sound box, but the front end of the diaphragm structure is further provided with the cavity. In the case where the volume of the rear sound box is too small to achieve the desired low frequency performance by itself, the cavity may enhance the low frequency performance of the speaker module by filtering out high frequency sound waves and/or by generating low frequency sound waves by resonance. Accordingly, it is not necessary to meet the requirement of low frequency performance by increasing the volume of the rear sound box, thereby saving the configuration space of the speaker module in the electronic device.

Although the embodiments are already disclosed as above, these embodiments should not be construed as limitations on the scope of the disclosure. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A speaker module, comprising:
a diaphragm structure having a front end and a rear end that are opposite to each other;
a rear sound box connecting to the rear end of the diaphragm structure; and
a cavity connecting to the front end of the diaphragm structure and having a sound output opening.

2. The speaker module as recited in claim 1, wherein a volume of the rear sound box is greater than 0 ml and less than 4 ml.

3. The speaker module as recited in claim 1, wherein the cavity comprises a waveguide, and the sound output opening is formed at an end of the waveguide.

4. The speaker module as recited in claim 3, wherein the cavity comprises a front sound box that is connected between the front end and the waveguide.

5. The speaker module as recited in claim 3, wherein the waveguide comprises at least one bent portion, and the at least one bent portion is connected between two sections of the waveguide that are parallel to each other.

6. The speaker module as recited in claim 3, wherein another end of the waveguide connects to the diaphragm structure.

7. The speaker module as recited in claim 3, wherein the speaker module is adapted to generate a sound wave having a low frequency from the sound output opening, and a length of the waveguide is a multiple of a quarter of a wavelength of the low frequency.

8. The speaker module as recited in claim 7, wherein the low frequency is not greater than 300 Hz.

9. The speaker module as recited in claim 1, wherein the diaphragm structure comprises a housing and a diaphragm, the diaphragm is disposed inside the housing and divides an interior of the housing into a first space and a second space, and the first space connects to the rear sound box and the second space connects to the cavity.

10. The speaker module as recited in claim 1, wherein the diaphragm structure comprises a diaphragm adapted to vibrate along a vibration direction, the rear sound box, the diaphragm structure and the cavity are sequentially arranged along an arrangement direction, and the vibration direction is perpendicular to the arrangement direction.
